(19) United States
(12) Patent Application Publication
(10) Pub. No.: US 2026/0343010 A1
(43) Pub. Date: Oct. 29, 2026

(54) METHOD FOR FLEXIBLE QUANTIZATION OF MEDIA

(71) Applicant: Nokia Technologies Oy, Espoo (FI)

(72) Inventors: Lauri Aleksi ILOLA, Tampere (FI); Lukasz KONDRAD, Munich (DE); Patrice RONDAO ALFACE, Antwerp (BE); Daniele MARI, Antwerp (BE)

(21) Appl. No.: 19/654,821

(22) Filed: Apr. 22, 2026

Related U.S. Application Data
(60) Provisional application No. 63/795,173, filed on Apr. 25, 2025.

(51) Int. Cl. H04N 19/46; H04N 19/124; H04N 19/70; H04N 19/91

(52) U.S. Cl. CPC H04N 19/46; H04N 19/124; H04N 19/70; H04N 19/91

(57) ABSTRACT

In an example embodiment, an apparatus includes at least one processor; and at least one memory storing instructions that, when executed by the at least one processor, cause the apparatus at least to: receive one or more media frames each represented by one or more volumetric primitives; determine precision presets for processing the one or more volumetric primitives; process attributes of the one or more volumetric primitives according to the determined precision presets; associate the processed one or more volumetric primitives with the determined precision presets; store the processed one or more volumetric primitives in a bitstream; and store, in or along the bitstream, the determined precision presets and the association of the determined precision presets with the processed one or more volumetric primitives.

### TECHNICAL FIELD

The examples and non-limiting embodiments relate generally to a method for flexible quantization of media.

### BACKGROUND

It is known to process and render video in a multimedia system.

### BRIEF DESCRIPTION OF THE DRAWINGS

The foregoing embodiments and other features are explained in the following description, taken in connection with the accompanying drawings, wherein:

FIG. 1 is an illustration of a Gaussian splat.

FIG. 2 is an illustration of spherical harmonics on the left and a visual comparison with DCT basis functions on the right.

FIG. 3 shows an association of precision presets with the content.

FIG. 4 shows an encoder according to an embodiment.

FIG. 5 shows a decoder according to an embodiment.

FIG. 6 is a block diagram illustrating a system in accordance with an example.

FIG. 7 is an example apparatus configured to implement the examples described herein.

FIG. 8 shows a representation of an example of non-volatile memory media used to store instructions that implement the examples described herein

FIG. 9 is an example method based on the examples described herein.

FIG. 10 is an example method based on the examples described herein.

### DETAILED DESCRIPTION OF EXAMPLE EMBODIMENTS

### Volumetric Content

There are many ways to capture and represent a volumetric scene. The format used to capture and represent it depends on the processing to be performed on it, and the target application using it. Some exemplary representations are listed below.
A volumetric frame can be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors)
A volumetric frame can be represented as images, with or without depth, captured from multiple view-points in 3D space. In other words, it can be represented by one or more view frames where a view is a projection of a volumetric scene on to a plane (the camera plane) using a real or virtual camera with known/computed extrinsic and intrinsic parameters. Each view may be represented by a number of components (e.g. geometry, color, transparency, and occupancy picture), which may be part of the geometry picture or represented separately.
A volumetric frame can be represented as a mesh. Mesh is a collection of points, called vertices, and connectivity information between vertices, called edges. Vertices along with edges form faces. The combination of vertices, edges and faces can uniquely approximate shapes of objects.
A volumetric frame can be represented as an implicit neural radiance field such as the Neural Radiance Field (NeRF) representation for example. A NeRF is a representation of a 3D scene that is parameterized by a deep neural network (DNN). The network predicts a volume density and view-dependent emitted radiance given the spatial location (x, y, z) and viewing direction, e.g., in Euler angles (θ, Φ) of the camera. Volume rendering techniques can produce an image by sampling points along rays intercepted by the camera projection model.

A volumetric frame can be represented as a radiance field such as the Gaussian Splatting (a.k.a., 3DGS, 4DGS, Gaussian Splat) representation. This representation can be seen as a point cloud representation with additional attributes that model the geometry and appearance of the scene in the close neighborhood of a position (x, y, z). Rendering of radiance fields represented as Gaussian splats and other variants using modified versions of the attributes may be performed by simple and fast rasterization or more accurate volume rendering using ray tracing.

Depending on the capture, a volumetric frame can provide viewers the ability to navigate a scene with six degrees of freedom, i.e., both translational and rotational movement of their viewing pose (which includes yaw, pitch and roll). The data to be coded for a volumetric frame can also be significant, as a volumetric frame can contain large numbers of objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression.

### Point Cloud

A point cloud is a data structure that can be used to represent a three-dimensional scene. Point clouds consist of a set of points in a coordinate system. Each point is defined by its three coordinates and may be associated with zero or more attributes. Attributes can have different types and are used to describe the properties of a point, such as its color or reflectance. Point clouds are created by sensors such as Lidar (“light detection and ranging”) or Radar (“radio detection and ranging”) sensors or by depth cameras or by multi-camera setups or by ultrasound devices or by other distance sensing devices or combinations one or more of the above and, optionally, other devices. There are many use-case scenarios for point clouds. An example use case is a vehicle that uses one or multiple sensors to scan its environment to create a point cloud describing its surroundings. The point clouds can then be used for further processing, e.g., for creating a virtual mapping of the environment, for autonomous driving use cases, or for teleoperation. In some cases, further processing has to be done on a device different from the one that captured the point cloud. In those cases, point clouds or sequences of point clouds have to be transmitted over a network. Due to the large amount of data that point cloud sequences produce, transmitting the data in real-time is challenging. In addition to the use of efficient codecs to reduce the data rate, it may be beneficial to lower the bandwidth requirements by prioritizing certain parts of a point cloud and allowing other parts to be removed from the point cloud before transmission. Moreover, transmission channels (such as wireless networks, packet networks, or other potentially unreliable channels) may not deliver all point cloud data intact, in which case, possibly selective, repair mechanisms may be beneficial.

### Geometry-Based Point Cloud Compression (G-PCC)

G-PCC is an encoding mechanism defined by the Moving Picture Experts Group (MPEG) to reduce the size of a point cloud. G-PCC encodes point clouds with a number of tools that are especially efficient for sparse point cloud data. The geometry of the point cloud is first encoded as an octree and attributes are coded depending on the geometry, in other words, the attribute coding relies on reconstructed geometry data that can be reproduced exactly at encoder and decoder to avoid coding drifts and errors for attributes. Different tools are available after octree decomposition within G-PCC specifications, such as “trisoup” that consists in a surface approximation based on a set of triangles defined on octree leaves, and such as predictive occupancy octree coding. Attributes are typically transferred from the original point cloud to the reconstructed geometry. Attributes may be coded with a Level of Detail (LoD)-based approach combined with a predictive transform and optionally a Lifting Transform. As an alternative approach to LoDs, a Region-Adaptive Hierarchical Transform (RAHT) introduced interesting inter prediction compression performances. In the emerging G-PCC edition 2, these tools have been extended and complemented, offering more access granularity to LoDs, adaptive quantization per LoD, cross-attribute prediction within a LoD, LoD attribute slices, enhanced coding of DC and AC components of RAHT, and overall, a better point cloud inter prediction performance.

### Visual Volumetric Video-Base Coding (V3C)—ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MIV (ISO/IEC 23090-12). MIV and V-PCC use number of V3C syntax elements with a slightly modified semantics.

MPEG 3DG (ISO SC29 WG7) group has started work on a third application of V3C—the mesh compression (ISO/IEC 23090-29). It is also envisaged that mesh coding will re-use V3C syntax as much as possible and can also slightly modify the semantics.

### Gaussian Splats

Gaussian splats can be seen as point clouds with additional information per point:
Position (x,y,z), i.e., position of the point
Scale (sx,sy,sz); i.e., non-uniform scale factor of the Gaussian splat
Rotation (rx,ry,rz) or (qx,qy,qz,qw); i.e., the rotation of the Gaussian splat with respect to world coordinates, the rotation is expressed by Euler angles or quaternions
Normal (nx, ny, nz); i.e., the normal vector of the Gaussian splat
Opacity (alpha), i.e., a factor that indicates the transparency of the Gaussian splat
Color (r,g,b), i.e., the primary color of the Gaussian splat
Spherical harmonics (e.g. SH [0:48]), i.e., the reflectance of the Gaussian splat expressed in spherical harmonics.

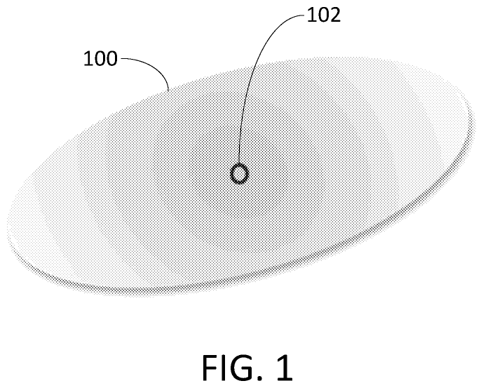

FIG. 1 is an illustration of a Gaussian Splat 100. The position information is for example given by its center 102 highlighted by a circle. The size and orientation of the shape of the splat is determined by the scale and rotation. The color, transparency and reflectivity are defined by the spherical harmonics and opacity.

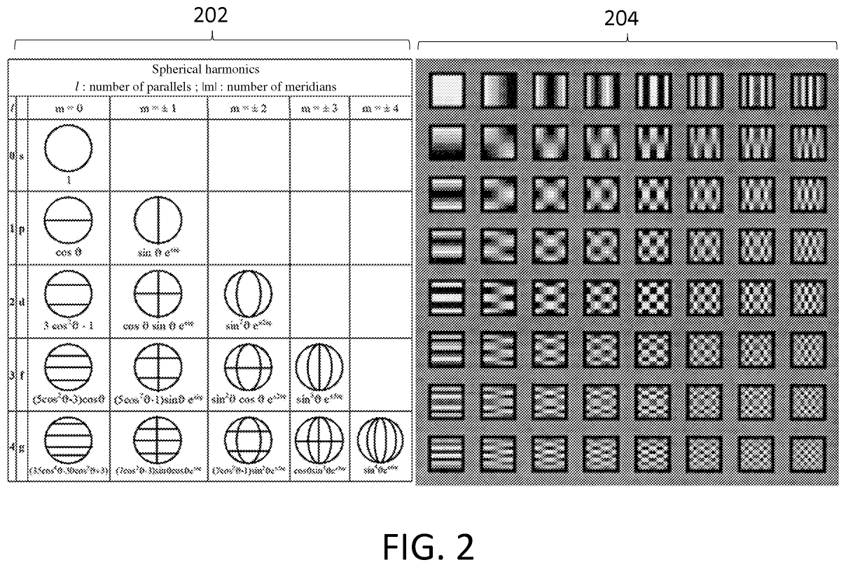

Sometimes color is represented by the DC component of spherical harmonics, and spherical harmonics contain 45 non-DC components. Spherical harmonics can be seen as DCT basis functions defined on the sphere (see FIG. 2).

The rendering function for a Gaussian splat can be expressed as follows:

$${g}_{i} ( p ) = α exp ( - \frac{1}{2} ( p - {μ}_{i} ) {\sum }_{i}^{- 1} ( p - {μ}_{i} ) )$$

Where Σ is the covariance matrix and is equal to:

Σ=RSS^{T}R^{T}

Where R is a 3×3 rotation matrix expressed with 4 quaternions and S is a diagonal scaling matrix with 3 parameters for scale.

FIG. 2 provides an illustration of spherical harmonics on the left (202), and a visual comparison with DCT basis functions on the right (204).

Similarly to DCT, that enables low to high frequency variations on the horizontal and vertical axis of an image, increasing order of spherical harmonics shows increasing frequency variations in vertical and horizontal directions on the sphere. The first component (m=0, l=0), referred to as DC represents a constant value over the sphere, the second component (m=0, l=1) enables a variation from south pole to north pole following cos (theta), the third component enables a variation from one side of the equator to the other side, etc. Multiplying the three color components RGB to these 15 basis functions on the sphere leads to 45 spherical harmonics components. Some approaches achieve a fast estimation of the Spherical harmonics transform and inverse transform by relying on the FFT.

Other variants of radiance fields representations include:
Spherical point clouds, which are similar to Gaussian splats except that the shape is spherical, i.e., there is only one scale factor and there is no rotation attribute data and no falloff due to the Gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats, but the rendering equation is defined on a rectangle.
2DGS or surfels, similar to Gaussian splats but where the smallest scale is set to zero and a normal is defined. These are typically defined on surfaces in the tangent space. The rendering equation is the same as for Gaussian splats.
Gaussian splats with neural appearance attributes, where view dependent appearance is represented by latent variables. The rendering equation requires a MLP to decode the latent appearance.

Some variants of Gaussian splats do not explicitly encode a unique center position with extra attributes, but do not prevent from coding or deriving such center position. For example, billboards of Gaussian Textures describe a rectangular tile on which the Gaussian splat representation is defined instead of a single central point. Another example is 3D Convex Splatting (3DCS) that encode a polygonal shape containing N points without encoding any central position. Nevertheless, the appearance attributes are similar to 3DGS as well as the rendering and learning strategy used to model those from input camera views.

### Coding of Gaussian Splats

Several of coding/representation formats are available for Gaussian splats:
SPZ format for static Gaussian splats [source: https://github.com/nianticlabs/spz]
PLY format
G-PCC with extensions

### SPZ Format

The .spz format is a gzipped stream of data consisting of a 16-byte header followed by the Gaussian data. This data is organized by attribute in the following order: positions, scales, rotations, alphas, colors, spherical harmonics. The .spz data starts with header information, in little-endian format.

TABLE 1
.spz header information

| PackedGaussianHeader ( ) | |
|---|---|
| uint32_t | magic; |
| uint32_t | version; |
| uint32_t | numPoints; |
| uint8_t | shDegree; |
| uint8_t | fractionalBits; |
| uint8_t | flags; |
| uint8_t | reserved; |

The values and semantics of the fields in the header are specified as follows:
magic: 0x5053474e
version: 2
numPoints: number of encoded Gaussians
shDegree: The degree of spherical harmonics. This must be between 0 and 3 (inclusive).
fractionalBits: number of bits used to store the fractional part of coordinates in the fixed-point encoding.
flags: bit field containing flags.
0x1: whether the splat was trained with antialiasing.
reserved: Reserved for future use. Must be 0.

The header is then followed by positions, scale, rotation, alpha, color, and spherical harmonics data.

Positions are represented as (x, y, z) coordinates, each as a 24-bit fixed point signed integer. The number of fractional bits is determined by the fractionalBits field in the header.

Scales are represented as (x, y, z) components, each represented as an 8-bit log-encoded integer.

Rotations are represented as the (x, y, z) components of the normalized rotation quaternion. The w component can be derived from the others and is not stored. Each component is encoded as an 8-bit signed integer.

Alphas are represented as 8-bit unsigned integers.

Colors are stored as (r, g, b) values, where each color component is represented as an unsigned 8-bit integer.

Depending on the degree of spherical harmonics for the splat, this can contain 0 (for degree 0), 9 (for degree 1), 24 (for degree 2), or 45 (for degree 3) coefficients per Gaussian.

The coefficients for a Gaussian are organized such that the color channel is the inner (faster varying) axis, and the coefficient is the outer (slower varying) axis, i.e. for degree 1, the order of the 9 values is: sh1n1_r, sh1n1_g, sh1n1_b, sh10_r, sh10_g, sh10_b, sh1p1_r, sh1p1_g, sh1p1_b

Each coefficient is represented as an 8-bit signed integer. Additional quantization can be performed to attain a higher compression ratio. This library currently uses 5 bits of precision for degree 0 and 4 bits of precision for degrees 1 and 2, but this may be changed in the future without breaking backwards compatibility.

### PLY Format

PLY is a file format known as the Polygon File Format and it is designed to store three-dimensional data. PLY supports a relatively simple description as a list of variety of properties, including position, color, transparency, surface normal, texture coordinates, etc., The format starts with header which follow by numerical data. The numerical data can be represent in ASCII or binary format and can be identified by the header information. PLY is utilized to represent Gaussian splats by INRIA format that stores position, rotation, color, scale, alpha, and spherical harmonics.

### Extension of G-PCC

G-PCC (ISO/IEC 23090-9) was developed for lossy compression of spare point clouds with arbitrary attributes. An extension of G-PCC that requires a simple modification to code quaternions and add the required metadata for pre- and post-processing attributes is under discussion in ISO SC29 WG7. The extension of G-PCC allows for Gaussian Splats coding is using following notations:
geometry: xyz positions of points
sh0: DC values of the spherical harmonics
sh1: first 3 AC values of the spherical harmonics
sh2: next 5 AC values of the spherical harmonics
sh3: last 7 AC values of the spherical harmonics
opacity: opacity
scale: scale
rotation: rotation

G-PCC is used to encode positions as point clouds and the additional Gaussian splat attributes are encoded with (Region-Adaptive Hierarchical Transform) RAHT.

shows comparison between PLY/INRIA format and SPZ format.

TABLE 2
Data types and precision for Gaussian attributes
in SPZ and PLY/INRIA and G-PCC.

| Element | SPZ Format | PLY Format | G-PCC format |
|---|---|---|---|
| Positions | 24-bit fixed point | 32-bit or 64-bit | 3 × 18-bits |
| | integer with | floating-point | |
| | adjustable | | |
| | fractional bits | | |
| Rotation | 3 components of a | 4 components of | 4 × 12 bits |
| | quaternion stored | quaternion as 32-bit | |
| | as 8-bit signed | floats | |
| | integers | | |
| Colors or DC | 8-bit unsigned | 8-bit or 32-bit floats | 3 × 12 bits |
| components of the | integers per | per channel | |
| spherical harmonics | channel | | |
| Scales | 8-bit log-encoded | 32-bit or 64-bit | 3 × 12 bits |
| | integer | floating-point | |
| Alphas | 8-bit unsigned | 32-bit float | 12 bits |
| (Transparency) | integer | | |
| Spherical Harmonics | 8-bit signed | Varies, but usually | sh1 3 × 3 × 12 bits |
| | integers for | stored with higher | sh2 5 × 3 × 12 bits |
| | coefficients, with | precision (e.g., 32- | sh3 7 × 3 × 12 bits |
| | 4-5 bits of | bit floats) | |
| | precision | | |

### Descriptor Convention.

Throughout the document we use descriptors to specify the parsing process of a syntax element. The descriptor definition is same as in ISO/IEC 23090-5, for example:
u(n): unsigned integer using n bits. When n is “v” in the syntax table, the number of bits varies in a manner dependent on the value of other syntax elements. The parsing process for this descriptor is specified by the return value of the function read_bits(n), specified in ISO/IEC 23090-5, interpreted as a binary representation of an unsigned integer with the most significant bit written first. When n is equal to 0, the associated syntax element is not present in the bitstream and its corresponding value shall be inferred to be equal to 0 unless specified otherwise in the semantics.
ue(v): unsigned integer 0-th order Exp-Golomb-coded syntax element with the left bit first.

### Some Background on Artificial Intelligence (AI) and Neural Networks

A neural network (NN) may be described as a computation graph consisting of several layers of computation. Each layer may consist of one or more units, where each unit performs an elementary computation. A unit is connected to one or more other units, and the connection may be associated with a weight. The weight may be used for scaling the signal passing through the associated connection. Weights are learnable parameters, e.g., values which can be learned from training data. There may be other learnable parameters, such as those of batch-normalization layers.

In some neural networks, such as convolutional neural networks for image classification, initial layers (those close to the input data) extract semantically low-level features such as edges and textures in images, whereas intermediate layers extract more high-level features. After the feature extraction layers there may be one or more layers performing a certain task, such as classification, semantic segmentation, object detection, denoising, style transfer, super-resolution, etc.

Neural networks are being utilized in an ever-increasing number of applications for many different types of devices, such as mobile phones. Examples include image and video analysis and processing, social media data analysis, device usage data analysis, etc.

One property of neural nets (and other machine learning tools) is that they are able to learn properties from input data, e.g., in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss or loss function. Examples of losses are mean squared error, cross-entropy, etc. In recent deep learning techniques, training is an iterative process, where at each iteration the algorithm modifies the weights of the neural net to make a gradual improvement of the network's output, e.g., to gradually decrease the loss, by means of gradient descent technique. In one example, at each training iteration, gradients of the loss function with respect to one or more weights or parameters of the NN are computed, for example by backpropagation technique; the computed gradients are then used by an optimization routine, such as Adam or Stochastic Gradient Descent (SGD) to obtain an update to the one or more weights or parameters.

The terms “model”, “neural network”, “neural net” and “network” are used interchangeably herein, and also the weights of neural networks are sometimes referred to as learnable parameters or simply as parameters.

Training a neural network is an optimization process, but the final goal may be different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, e.g., data which was not used for training the model. This is usually referred to as generalization. In practice, data is usually split into at least two sets, the training set and the validation set. The training set is used for training the network, e.g., to modify its learnable parameters in order to minimize the loss. The validation set is used for checking the performance of the network on data which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model may be in the regime of overfitting. This means that the model has just memorized the training set's properties and performs well only on that set, but performs poorly on a set not used for tuning its parameters.

The terms visual temporal extrapolation, temporal extrapolation, and video prediction may be used interchangeably. Visual temporal extrapolation may be defined as a method, algorithm, or process that generates one or more pictures in the future given one or more past pictures as input. Visual temporal extrapolation may be realized by, but is not necessarily based on or limited to, neural network inference.

Example use cases for visual temporal extrapolation include, but are not limited to:
Very low delay computer vision for domains like robotics and autonomous driving, where extrapolated future pictures facilitate anticipatory decision making;
Increase of the rendered picture rate in very low-latency applications, such as cloud gaming, relative to the decoded picture rate;
Reduction of the end-to-end delay in low-latency applications through extrapolating and displaying future pictures before they are received; and
Generative face video for very low bitrate video coding.

The term generative artificial intelligence (AI), or generative modeling, or generative machine learning (and other similar terms), are commonly used to indicate a class of models learned from data that are capable of generating new data. State-of-the-art generative models are based on neural networks. The basic components or layers of a generative NN are usually not different from the components or layers of a non-generative NN. Example of such components are convolution layers, non-linear layers, fully-connected layers, normalization layers, attention layers, etc.

One typical example of neural network architecture that allows for generating text data is a Transformer-based “decoder”, where “decoder” may not refer to a decoder that is part of a codec performing compression of input data into a small bitstream. Instead, the decoder is a neural network that gets a set of input words or parts of words or tokens extracted from input words, and outputs a set of output words or parts of words or tokens. At inference time, such a NN is run in auto-regressive mode, where the generated word(s) or token(s) is provided as part of the input word(s) or token(s). In order for such a NN to generate data, it is trained to predict the next word(s) (or an estimate of a probability distribution over the next words) given a set of input words. The NN may be based on the Transformer architecture, which comprises the use of the self-attention mechanism, where an attention score is assigned to each input token or word based on all other input tokens or words, including the previously generated words or tokens. During training of a decoder-style Transformer architecture, the future data items (words or tokens) are masked so not to leak information from the future. In some cases, decoder-style Transformer architectures are referred to as “uni-directional”, because they use or process information from left-to-right, as opposed to some encoder-style Transformer architectures that are referred to as “bi-directional” (because they use or process information from left-to-right and from right-to-left).

Another example of generative modeling is visual temporal extrapolation, where a picture is generated by a NN based on one or more previously decoded or generated pictures and on one or more other data items. The one or more previously decoded or generated pictures may be pictures decoded by a process that does not involve generative modeling, such as a traditional codec, e.g., a VVC-compliant codec. The one or more data items may include parameters or features that describe the differences between the one or more previously decoded pictures and the current picture to be temporally extrapolated. Examples of such parameters are facial parameters (such as facial keypoints or facial landmarks and their positions or differential positions with respect to the facial landmarks of a previous picture), or parameters of other objects. The one or more data items may be signaled from encoder to decoder.

A hierarchical model of 3DGS representations may be implemented, including hierarchical structure information that provides quantization and precision information for a given primitive (primitive_position_bit_depth, primitive_geometric_attributes_bit_depths[0], primitive_position_bit_depth[i], primitive_geometric_attributes_bit_depths[i]). However, the quantization and precision are limited per hierarchical level in the tree and only applicable to position and geometry components of the volumetric representation.

TABLE 4
3DGS hierarchical_structure_information.

| | Descriptor |
|---|---|
| hierarchical_structure_information( ) { | |
| tree_type | u(2) |
| lod_count_minus1 | ue(v) |
| primitive_type[0] | u(4) |
| number_primitives_level_0 | u(8) |
| number_primitives_current_level=number_primitives_level_0 | |
| for(i=0; i<num_primitives_level_0; i++){ | |
| children_count_minus1[0][i] | ue(v) |
| } | |
| primitive_position_bit_depth[0] | u(6) |
| primitive_geometric_attributes_bit_depths[0] | u(3) |
| code_primitive_position_with_octree[0] | u(2) |
| appearance_attributes transform[0] | u(2) |
| If (primitive_type[i] < 3) { //gaussian or ellipsoid | |
| code_covariance[0] | u(1) |
| } | |
| for(i=1; i<lod_count_minus1 + 1; i++) { | |
| primitive_type[i] | u(4) |
| primitive_position_bit_depth[i] | u(6) |
| primitive_geometric_attributes_bit_depths[i] | u(3) |
| code_primitive_position_with_octree[i] | u(1) |
| num_parallel_decode[i] | u(16) |
| weights_are_uniform[i] | u(1) |
| If (primitive_type[i] < 3) { //Gaussian or ellipsoid | |
| code_covariance[i] | u(1) |
| } | |
| appearance_attributes_transform[i] | u(2) |
| appearance_transform_metadata[i] | ue(v) |
| number_primitives_next_level = 0 | |
| for(j=0; j<number_primitives_current_level ; j++){ | |
| If ( i < lod_count_minus_1){ | |
| primitive_count_minus1[i][j] | ue(v) |
| number_primitives_next_level += primitive_count_minus1[i][j] + | |
| 1 | |
| } | |
| If ( ! weights_are_uniform[i]){ | |
| aggregation_weights[i][i] | ue(v) |
| } | |
| } | |
| number_primitives_current_level = number_primitives_next_level | |
| } | |
| } | |

Generally, quantization of data is a necessary step for data compression. Raw or mezzanine capture formats and representations tend to over-allocate precision of data structures to accommodate wide variety of content and use cases. The same principle applies for compression of volumetric representations, such as for example 3D gaussian splats (3DGS). The original 3DGS representation from INRIA uses floating point precision for storing the parameters of the 3D Gaussian primitives. SPZ-format as discussed in the background quantizes this representation into a more efficient representation without sacrificing much of the visual fidelity.

Because of the wide variety of different use cases of volumetric representations such as geospatial, industrial and medical use cases, where extreme high precision of representation is required, and consumer grade use cases such entertainment, where lower precision is accepted to deliver the 3DGS data through the existing networks, the underlying compression or representation format should also support flexible quantization and precision adjustment. Existing representation formats, such as SPZ, INRIA, G-PCC, hard code the quantization and precision information with maximum flexibility to adjust the quantization per content and doesn't consider temporal or spatial scalability of such signaling. Moreover, each representation format has different perspective on the precision of the data structures. This is likely due to different application or use case for which the particular representation was developed for.

Further flexibility of quantization should be considered to allow setting quantization for all components of the volumetric primitive per sequence, frame, per group of volumetric primitives (e.g. parent in a tree hierarchy) or even per primitive. The draw-back of introducing higher granularity of quantization options is that it introduces additional signaling that can increase the overall size of the data.

Table 4 illustrates different components for volumetric primitives and demonstrates the complexity of various combinations. For a practical application, it is beneficial to substantially limit the space of presets by determining different options that can be most useful.

TABLE 4
Combinations of different parameters signaling

| Element | Count | Data type | Precision | Combinations |
|---|---|---|---|---|
| Positions | 3 | Float, uint, int | 1-64 | 576 |
| Rotation | 3 | Float, uint, int | 1-32 | 288 |
| Colors (RGB, | 3 | Float, uint | 1-32 | 192 |
| YUV) | | | | |
| Scales | 1-3 | Float, uint | 1-64 | 384 |
| Alphas | 1 | Float, uint | 1-32 | 64 |
| (Transparency) | | | | |
| Spherical | 1-45 | Float, uint, int | 1-32 | 12960 |
| Harmonics | | | | |

Efficient means of signaling quantization can alleviate the problem and create even higher performing compression techniques.

Described herein is a method to enable quantization of data structures representing volumetric primitives adaptively even per primitive level in an efficient manner. The benefit of creating multiple precision presets and allowing volumetric primitives to be quantized differently within the representation is that it can enable better compression performance of volumetric primitives. It is expected that a volumetric representation consists of thousands if not millions of volumetric primitives which are distributed in the space non-uniformly. Finding a precision preset that allows quantizing all primitives with no visual loss or limited visual loss will likely over allocate the precision needed for some volumetric primitives, because there will be denser and emptier volumetric regions in the representation. Similarly, regions of the representation with more view dependent effects may require higher precision of visual attributes of volumetric primitives than regions with more diffuse surfaces.

Efficient and flexible signaling of precision presets can be achieved by defining means for determining different precision presets that can be indexed per primitive, group of primitives, frame or sequence to identify how the data structure of a given primitive is stored in a bitstream or file. The methods of the embodiments described herein allow for flexibility to optimize data structures of volumetric primitives to match the actual precision needed by a given use case yet maintaining the efficient means for associating the primitives with the corresponding precision presets. Furthermore, the quantization techniques of the embodiments described herein can be considered as a quality adaptation technique, similar to how content level adaptation can be done by generating alternative versions of the content using different global quantization values. Exposing these quantization values for streaming description protocol level could help client applications request content variations that fit the hardware or bandwidth at hand.

A precision preset is a collection of quantization values for different attributes of a volumetric primitive, that can be used for effectively representing volumetric primitives in the scene.

Example logic for encoder: receive one or more media frames each represented by one or more volumetric primitives, determine precision presets for processing volumetric primitives, process attributes of the volumetric primitives according to the determined precision presets, associate the processed volumetric primitives with the determined precision presets, store the processed volumetric primitives in a bitstream, and store the determined precision presets and their association to the processed volumetric primitives in or along the bitstream.

Example logic for decoder: receive a bitstream comprising of at least one or more processed volumetric primitives, one or more precision presets, and information associating precision presets with the processed volumetric primitives, extract the processed volumetric primitives from the bitstream as well as the precision presets and their association to the processed volumetric primitives, reconstruct/decode volumetric primitives from the processed volumetric primitives using the associated precision presets, and generate a media representation consisting of the volumetric primitives.

### Further Clarifications

Media frames may be represented by the following volumetric primitive types: 3D Gaussians, triangles, meshes, convex hulls, points, 3D ellipsoids

Volumetric primitives may have the following attributes: position, rotation and scale or covariance, color, alpha, opacity or transparency, view dependent color or spherical harmonics.

Each attribute of a volumetric primitive may be described by bit depth, data type, number of components or component index, quantization type, quantization direction, minimum attribute value, maximum attribute value.

For attributes with multiple components, each component of the attribute may be described differently (this can be useful especially for view dependent color or spherical harmonics, with different frequency components).

A precision preset is a collection of descriptions of the quantization/representation strategy for different attributes of volumetric primitives present in the scene.

The precision presets may be determined: by analyzing the distribution of volumetric primitives in the media frame or sequence of media frames, by analyzing the 3D neighborhood of clusters of volumetric primitives, by analyzing the visual attributes of the volumetric primitives, based on the bounding box size of the media frame, manually by content author, or by other means.

Precision presets may be also determined through a learned approach, whereby a scene and its primitives are rendered using different precision presets and their association with the volumetric primitives. Minimizing the visual loss compared to rendered ground truth (full-precision source content) or non-modified source view may be used as a guiding factor to determine the precision presets for the scene, sequence, frame, group of primitives or per primitive.

Precision presets can be generated for one or more of the following granularities per content, per sequence of frames, per frame, per level of detail, or per frame tile.

Associating precision presets and primitives can be on the one or more of the following granularities per primitive, per group of primitives, per hierarchy of primitives, or per level of detail.

The precision presets (or profiles associated with them) may be signaled in streaming protocol descriptions such as SDP or MPD for allowing quality-based adaptation of volumetric content.

### About Precision Presets

The method can be roughly summarized in the following three steps: determine precision presets for a presentation in a given granularity (content, sequence, frame, frame tile), process volumetric primitives with precision presets that fit them resulting in no perceivable visual loss or in visual loss if lossy quantization is deemed necessary, associate the processed volumetric primitives with the precision presets in a given granularity (per primitive, group of primitives, level of detail, level of hierarchy).

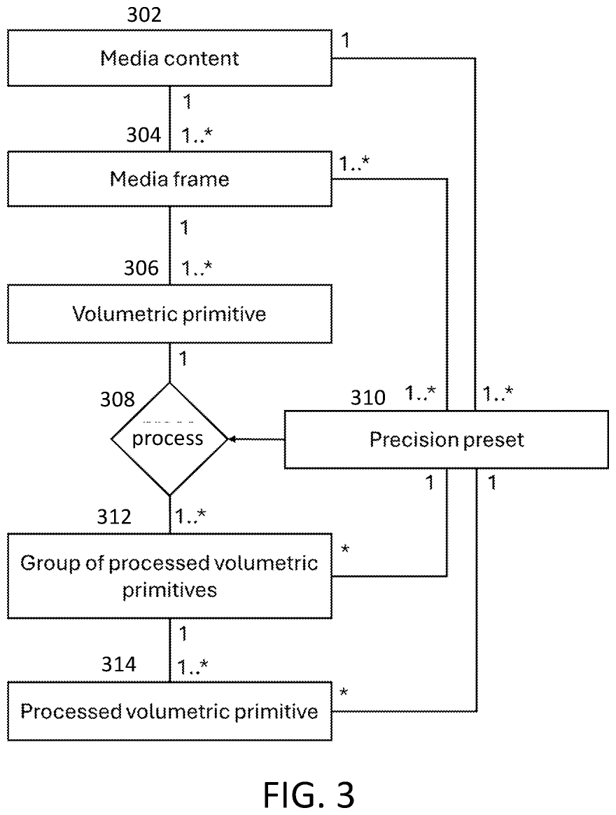

FIG. 3 illustrates how the precision presets can be signaled at different granularities. A group of volumetric primitives is considered only a collection of volumetric primitives. It can be a collection associated with a level of detail, hierarchy or other spatially related group of primitives.

Thus, FIG. 3 shows an association of precision presets with the content, including the one or more relationships between media content 302, media frame 304, volumetric primitive 306, process 308, precision preset 310, group of processed volumetric primitives 312, and process volumetric primitive 314.

One precision preset contains a set of descriptions for quantizing different attributes of a volumetric primitive. Multiple precision presets can be used for quantizing the content. One preset always associated with at least one primitive or collection of primitives. One primitive should not be associated with more than on precision preset, unless quantization is used for content adaptation. Precision presets can be generated by analyzing the media content and the distribution of volumetric primitives in it. The analysis can for example consider the density distribution of volumetric primitives in the content. It can further consider the visual attributes of the volumetric primitives to determine precision presets that work well, for a particular type of physical properties of a surface, i.e., volumetric primitives corresponding to specular surfaces might receive similar precision presets and diffuse surfaces would receive different precision presets. Precision presets can also be configured by hand based on for example general dimensions of the scene and desired resolution of quantization.

There is also an option for learning the precision presets together with the volumetric primitives. A scene and its primitives can be rendered using different precision presets and their association with the volumetric primitives. Minimizing the visual loss compared to rendered ground truth (full-precision source content) or non-modified source view may be used as a guiding factor to determine the visually lossless or near lossless precision presets and their association with the volumetric primitives. Additionally with a learned approach a rate-distortion optimization procedure can also be carried out thus choosing the optimal presets for the chosen rate distortion tradeoff. In one embodiment this is done by approximating quantization with a straight-through estimator and by building a model of the rate that depends on the parameters of the presets. This allows to estimate the rate and the distortion under the chosen preset while making all operations fully differentiable thus allowing to run gradient descent based optimization.

A precision preset describes quantization of attributes for a volumetric primitive. precision_presets( ) contain one or more precision presets as illustrated in Table 5 that can be used to quantize all the primitives in the content. Different primitives may be linked to different precision presets temporally or spatially. The general logic is that there are likely multiple precision presets, but vastly lower number than there are of volumetric primitives.

The syntax structure in Table 5 should be considered as an example of precision presets. It explicitly indicates the type of data that a precision preset can comprise of. In practice some of the information can be signaled implicitly or associated with the precision presets via other means. In practice the syntax structure may contain a subset of this information, the bit-allocations may be different, the naming of variables or structures may differ. Some variables may be behind flags that determine their presence, or their presence may be implied by attribute_type or data_type values.

TABLE 5
Example of syntax for a precision preset data structure

| | Descriptor |
|---|---|
| precision_presets( ) { | |
| num_presets_minus1 | u(8) |
| num_attributes_minus1 | u(6) |
| for(i=0; i<num_presets_minus1 + 1; i++) { | |
| precision_preset_id | u(8) |
| for(j=0; j<num_attributes_minus1 + 1; j++) { | |
| attribute_type | u(4) |
| bit_depth | u(6) |
| data_type | u(2) |
| quantization_type | u(3) |
| quantization_direction | u(1) |
| min_range | ue(v) |
| max_range | ue(v) |
| component_index | u(8) |
| } | |
| } | |
| } | |

num_presets_minus1+1 indicates the number of precision presets stored in the data structure.

num_attributes_minus1+1 indicates the number of attributes for volumetric primitives.

precision_preset_id is a unique identifier for the precision set that can be references from other data structures.

attribute_type indicates the type of the attribute associated with a volumetric primitive. The attribute types are indicated in the Table 6.

TABLE 6
shows a mapping of attribute_type values
to attributes of volumetric primitives.

| attribute_type | ID |
|---|---|
| position | 0 |
| rotation | 1 |
| scale | 2 |
| covariance | 3 |
| color | 4 |
| opacity | 5 |
| transparency/alpha | 6 |
| viewDependentColor | 7 |
| sh0 | 8 |
| sh1 | 9 |
| sh2 | 10 |
| sh3 | 11 |
| reserved | 12-62 |
| undefined | 63 |

bit_depth determines the number of bits used to store the data, also known as precision.

data_type determines the type of the data structure. 0=unsigned integer, 1=integer, 2=floating point, 3=fixed point

quantization_type determines the method of quantization. 0=linear, 1=exponential, 2=normalized disparity, 3-7=reserved.

quantization_direction indicates the direction of the quantization law. 0=ascending, 1=descending.

min_range determines the minimum range of the quantized normalized data. The measure of units for the data is signaled via other means such as parameter sets or implied via the data_type of the volumetric primitive.

max_range determines that maximum range of the quantized normalized data. The measure of units for the data is signaled via other means such as parameter sets or implied via the data_type of the volumetric primitive.

component_index indicates which component of the attribute the data applies. For example, position attribute may have three components which are quantized using different precision or min_range and max_range. A value in the component index may be assigned to indicate that the same quantization is applied to all components of an attribute.

In one embodiment the precision presets can be further divided into visual attributes and geometry attributes. A precision preset can consist of a combination of one visual attribute preset and one geometry attribute preset. This may allow reusing geometry attribute presets when only visual attributes benefit from different quantization. The vice versa may be considered when the inverse effect is more dominant.

In another embodiment the syntax of the precision presets may be further divided and grouped. For example, the min_value and max_value can be signaled separately as a min-max-preset, whereas the rest of the description is stored in another preset. The final per primitive preset would then become a combination of related divided presets.

### Storing of Precision Presets

Precision presets may be signaled at different granularities. They may be determined once per content, per sequence, per frame or per frame tile. In theory even finer granularity for determining the precision presets is possible, but it may lead to overfitting and reducing the overall gains that can be achieved with the precision presets in general.

In one embodiment the precision presets are signaled once per content. Multiple precision presets may exist in the content level parameters, such as a v3c_parameter_set or its extension for example.

In another embodiment, the precision presets are signaled for a sequence of frames. Multiple precision presets may exist in the sequence level parameters.

In another embodiment, the precision presets are signaled per frame. Multiple precision presets may exist in the frame level parameters.

In another embodiment, the frame may be divided into tiles corresponding to a region in space. The precision presets may be signaled per frame tile. Multiple precision presets may exist in the frame tile level parameter sets.

About Associating Precision Presets with Volumetric Primitives

Precision presets can be associated with volumetric primitives at different granularities. The highest level of associating primitives with the precision presets is to indicate that all volumetric primitives in the content obey the same precision preset. This is how most of the volumetric content is handled today. The same precision preset can also be associated for all volumetric primitives in a sequence of frames or in a frame. The real benefit of precision presets however comes, when the primitives or groups of primitives in a frame, sequence or content can be associated with different precision presets.

In one embodiment each volumetric primitive in the scene is associated with an id that indicates the precision preset that was used to quantize the data in the syntax structure.

In one embodiment, when volumetric primitives are hierarchically categorized a parent node may contain the precision preset identifier for its children.

In one embodiment, when volumetric primitives contain level of detail identifiers that can be used to select volumetric primitives of similar visual or geographic quality, the level of detail information may be used as a control for selecting the precision preset identifier.

In one embodiment, the spatial collection of primitives associated with a preset index is defined by a bounding box, a convex hull, a logic combination of volumetric shapes such as unions or intersections of spheres, cylinders, etc., potentially cut by a plane or another shape.

In another embodiment, the spatial collection of primitives is associated with a set of octree indices determined by a Morton order, i.e., all nodes of the octree that contain the primitives are identified by their Morton order indices that can be coded in a sequence. A hierarchical approach can be used such that if a single and full octree octant describes the spatial collection of primitives, then a single index may be coded, while a more refined subtree of the octree would require a larger number of indices.

In one embodiment, presets may be determined by the spatial collection and another condition such as for example, primitives inside a spatial collection of primitives may be associated with different indices based on another criterion such as a level of detail index for example.

In one embodiment presets information can be further compressed by entropy coding the indexes of the presets. This can be efficiently done by 1) defining a distance function between presets (e.g. sum of the absolute difference between the values in the preset), 2) predicting a candidate preset (e.g. the preset of a neighboring primitive or a preset from a previous frame/group of frames), 3) defining a probability distribution over all possible presets by computing their distance from the predicted preset and assigning lower probabilities to presets that are far from the predicted one.

In one embodiment the precision preset identifiers are exposed on the media streaming description level to be used as a mechanism for selecting different quality adaptations of the content. In this embodiment, the media streaming description could be a Session Description Protocol or a Media Presentation Description.

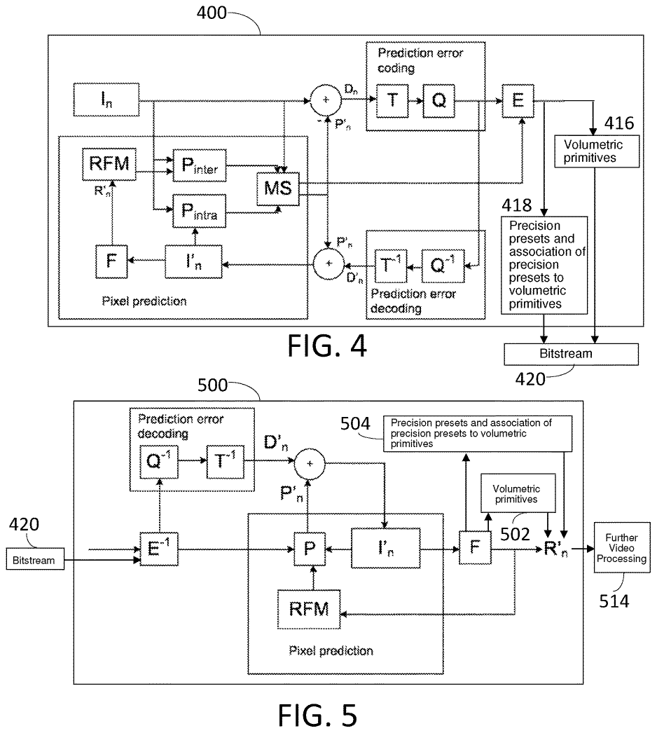

FIG. 4 shows an encoder 400 according to an embodiment. FIG. 4 illustrates an image to be encoded (Iₙ), a predicted representation of an image block (P′ₙ), a prediction error signal (Dₙ), a reconstructed prediction error signal (D′ₙ), a preliminary reconstructed image (I′ₙ), a final reconstructed image (R′ₙ), a transform (T) and inverse transform (T⁻¹), a quantization (Q) and inverse quantization (Q⁻¹), entropy encoding (E), a reference frame memory (RFM), inter prediction (Pᵢₙₜₑᵣ), intra prediction (Pᵢₙₜᵣₐ), mode selection (MS) and filtering (F).

FIG. 5 shows a decoder 500 according to an embodiment. FIG. 5 illustrates a predicted representation of an image block (P′ₙ), a reconstructed prediction error signal (D′ₙ), a preliminary reconstructed image (I′ₙ), a final reconstructed image (R′ₙ), an inverse transform (T⁻¹), an inverse quantization (Q⁻¹), an entropy decoding (E⁻¹), a reference frame memory (RFM), a prediction (either inter or intra) (P), and filtering (F).

Referring to FIG. 4, the output of E comprises coded video data and/or in some embodiments, level of detail geometry attributes data and/or appearance attributes data. Volumetric primitives 416 and precision presets and the association of the precision presets to the volumetric primitives are encoded into bitstream 420.

Referring to FIG. 5, one or more reconstructed frame(s) R′ₙ may contain a media representation including volumetric primitives 502. The volumetric primitives 502 are generated from the precision presets and the association of the precision presets to the volumetric primitives 504. The one or more reconstructed frame(s) R′ₙ may be input to further video processing 514.

A video encoder transforms the input video into a compressed representation suited for storage/transmission and a video decoder decompresses the compressed video representation back into a viewable form. Typically, an encoder discards some information in the original video sequence in order to represent the video in a more compact form (that is, at lower bitrate).

A video encoder may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, e.g., the difference between the predicted block of pixels and the original block of pixels, is coded. This is typically done by transforming the difference in pixel values using a specified transform (e.g., Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures (a.k.a. reference pictures).

Intra prediction utilizes the fact that adjacent pixels within the same picture are likely to be correlated. Intra prediction can be performed in spatial or transform domain, e.g., either sample values or transform coefficients can be predicted. Intra prediction is typically exploited in intra coding, where no inter prediction is applied.

An intra picture may be defined as a coded picture that is decoded using intra prediction only, or in other words, does not make use of inter prediction in decoding. An intra picture may be interchangeably called an intra frame.

An inter picture may be defined as a coded picture whose decoding may include intra prediction and inter prediction. An inter picture may be interchangeably called an inter frame.

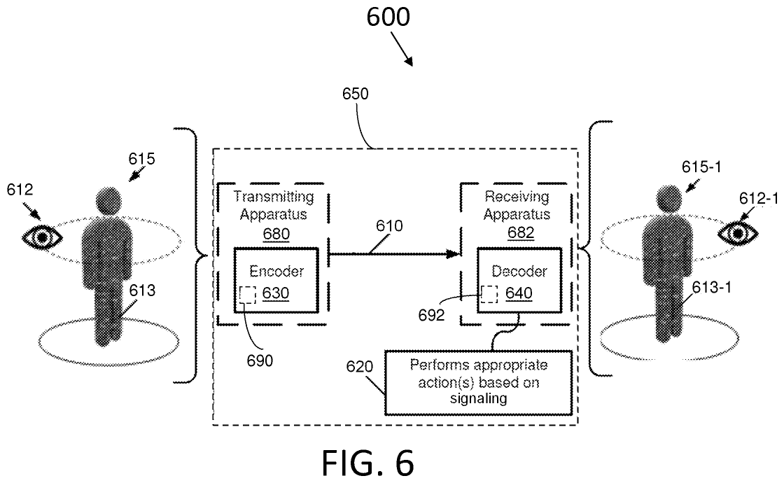

FIG. 6 is a block diagram illustrating a system 600 in accordance with several examples. In an example, the encoder 630 is used to encode an image or video from the scene 615, which scene 615 may be captured with one or more cameras, and the encoder 630 is implemented in a transmitting apparatus 680. The encoder 630 produces a bitstream 610 comprising signaling that is received by the receiving apparatus 682, which implements a decoder 640. The encoder 630 sends the bitstream 610 that comprises the herein described signaling. The decoder 640 forms the image or video for the scene 615-1, and the receiving apparatus 682 would present this to the user, e.g., via a smartphone, television, or projector among many other options.

In some examples, the transmitting apparatus 680 and the receiving apparatus 682 are at least partially within a common apparatus, and for example are located within a common housing 650. In other examples the transmitting apparatus 680 and the receiving apparatus 682 are at least partially not within a common apparatus and have at least partially different housings. Therefore in some examples, the encoder 630 and the decoder 640 are at least partially within a common apparatus, and for example are located within a common housing 650. For example the common apparatus comprising the encoder 630 and decoder 640 implements a codec. In other examples the encoder 630 and the decoder 640 are at least partially not within a common apparatus and have at least partially different housings, but when together still implement a codec.

In some examples, 3D media from the capture (e.g., volumetric capture) at a viewpoint 612 of the scene 615, which includes a person 613) is converted via projection to a series of 2D representations with occupancy, geometry, attributes and/or displacements. Additional atlas information is also included in the bitstream to enable inverse reconstruction. For decoding, the received bitstream 610 is separated into its components with atlas information; occupancy, geometry, displacement, and attribute 2D representations. A 3D reconstruction is performed to reconstruct the scene 615-1 created looking at the viewpoint 612-1 with a “reconstructed” person 613-1. The “-1” are used to indicate that these are reconstructions of the original.

In some examples, the scene 615 and reconstructed scene 615-1 are not limited to volumetric outside-in video as indicated by the eye representing viewpoint 612 circling the person 613 and the eye representing viewpoint 612-1 circling the reconstructed person 613-1. For example, the scene 615 may be a 2D frame or an image, and the reconstructed scene 615-1 may be a 2D frame or an image.

As indicated at 620, the decoder 640 performs an action or actions based on the received signaling.

Encoding 690 performs the examples described herein related to encoding of flexible quantization of media. Decoding 692 performs the examples described herein related to decoding of flexible quantization of media.

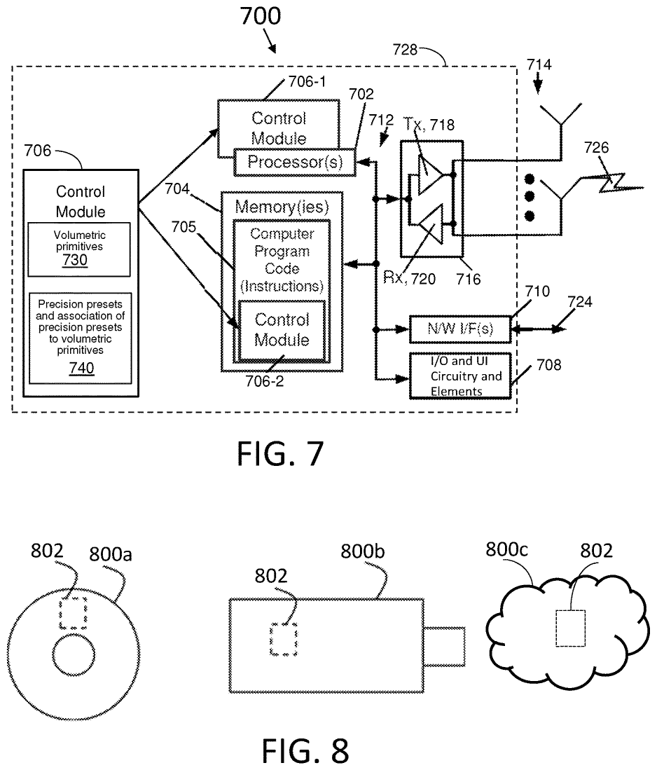

FIG. 7 is an example apparatus 700, which may be implemented in hardware, configured to implement the examples described herein. The apparatus 700 comprises at least one processor 702 (e.g., an FPGA and/or CPU and/or GPU), one or more memories 704 including computer program code 705, the computer program code 705 having instructions to carry out the methods described herein, wherein the at least one memory 704 and the computer program code 705 are configured to, with the at least one processor 702, cause the apparatus 700 to implement circuitry, a process, component, module, or function (implemented with control module 706) to implement the examples described herein.

Apparatus 700 may be a smartphone, personal digital device or assistant, smart television, laptop, pad, tablet, head-mounted display (HMD), or other user device or terminal device. The memory 704 may be a non-transitory memory, a transitory memory, a volatile memory (e.g. RAM), or a non-volatile memory (e.g., ROM).

Volumetric primitives 730 implements the examples described herein related to encoding and decoding of volumetric primitives. Precision presets and association of precision presets to volumetric primitives 740 implements the examples described herein related to encoding and decoding of precision presets and an association of the precision presets to volumetric primitives.

The apparatus 700 includes a display and/or I/O interface 708, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 700 includes one or more communication e.g. network (N/W) interfaces (I/F(s)) 710. The communication I/F(s) 710 may be wired and/or wireless and communicate over the Internet/other network(s) via any communication technique including via one or more links 724. The communication I/F(s) 710 may comprise one or more transmitters or one or more receivers.

The transceiver 716 comprises one or more transmitters 718 and one or more receivers 720. The transceiver 716 and/or communication I/F(s) 710 may comprise standard well-known components such as an amplifier, filter, frequency-converter, (de) modulator, and encoder/decoder circuitries and one or more antennas, such as antennas 714 used for communication over wireless link 726.

The control module 706 of the apparatus 700 comprises one of or both parts 706-1 and/or 706-2, which may be implemented in a number of ways. The control module 706 may be implemented in hardware as control module 706-1, such as being implemented as part of the one or more processors 702. The control module 706-1 may be implemented also as an integrated circuit or through other hardware such as a programmable gate array. In another example, the control module 706 may be implemented as control module 706-2, which is implemented as computer program code (having corresponding instructions) 705 and is executed by the one or more processors 702. For instance, the one or more memories 704 store instructions that, when executed by the one or more processors 702, cause the apparatus 700 to perform one or more of the operations as described herein. Furthermore, the one or more processors 702, one or more memories 704, and example algorithms (e.g., as flowcharts and/or signaling diagrams), encoded as instructions, programs, or code, are means for causing performance of the operations described herein.

The apparatus 700 to implement the functionality of control 706 may correspond to any of the apparatuses depicted herein. Alternatively, apparatus 700 and its elements may not correspond to any of the other apparatuses depicted herein, as apparatus 700 may be part of a self-organizing/optimizing network (SON) node or other node, such as a node in a cloud.

The apparatus 700 may also be distributed throughout the network including within and between apparatus 700 and any network element (such as a base station and/or terminal device and/or user equipment).

Interface 712 enables data communication and signaling between the various items of apparatus 700, as shown in FIG. 7. For example, the interface 712 may be one or more buses such as address, data, or control buses, and may include any interconnection mechanism, such as a series of lines on a motherboard or integrated circuit, fiber optics or other optical communication equipment, and the like. Computer program code (e.g. instructions) 705, including control 706 may comprise object-oriented software configured to pass data or messages between objects within computer program code 705. Computer program code (e.g. instructions) 705, including control 706 may comprise procedural, functional, or scripting code. The apparatus 700 need not comprise each of the features mentioned, or may comprise other features as well. The various components of apparatus 700 may at least partially reside in a common housing 728, or a subset of the various components of apparatus 700 may at least partially be located in different housings, which different housings may include housing 728.

FIG. 8 shows a schematic representation of non-volatile memory media 800a (e.g. computer/compact disc (CD) or digital versatile disc (DVD)) and 800b (e.g. universal serial bus (USB) memory stick) and 800c (e.g. cloud storage for downloading instructions and/or parameters 802 or receiving emailed instructions and/or parameters 802) storing instructions and/or parameters 802 which when executed by a processor allows the processor to perform one or more of the operations of the methods described herein. Instructions and/or parameters 802 may represent or correspond to a non-transitory computer readable medium.

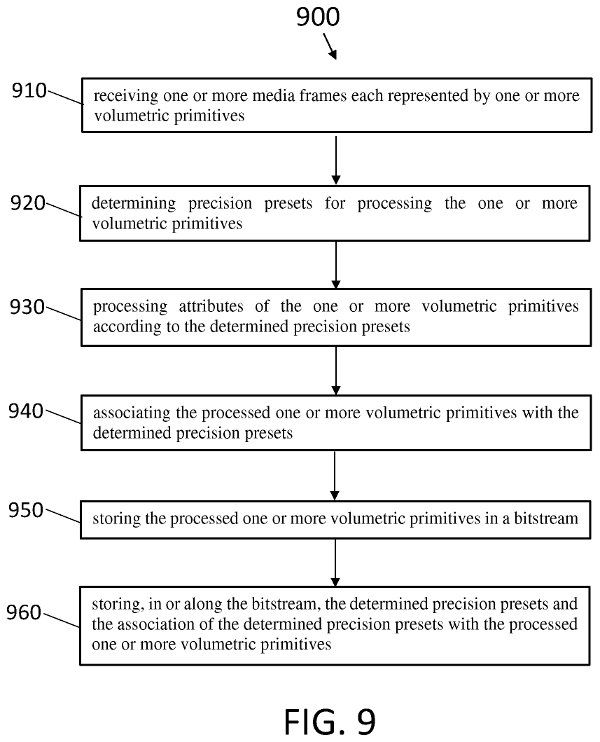

FIG. 9 is an example method 900 based on the examples described herein. At 910, the method includes receiving one or more media frames each represented by one or more volumetric primitives. At 920, the method includes determining precision presets for processing the one or more volumetric primitives. At 930, the method includes processing attributes of the one or more volumetric primitives according to the determined precision presets. At 940, the method includes associating the processed one or more volumetric primitives with the determined precision presets. At 950, the method includes storing the processed one or more volumetric primitives in a bitstream. At 960, the method includes storing, in or along the bitstream, the determined precision presets and the association of the determined precision presets with the processed one or more volumetric primitives. Method 900 may be implemented with encoder 400, transmitting apparatus 680 with encoder 630, or apparatus 700.

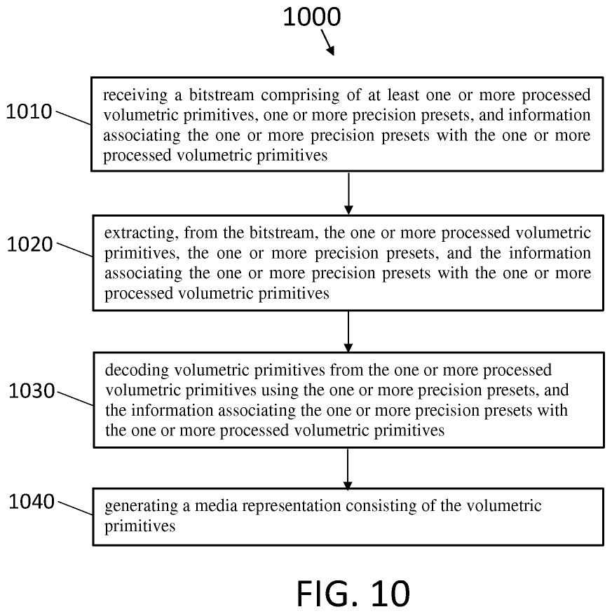

FIG. 10 is an example method 1000 based on the examples described herein. At 1010, the method includes receiving a bitstream comprising of at least one or more processed volumetric primitives, one or more precision presets, and information associating the one or more precision presets with the one or more processed volumetric primitives. At 1020, the method includes extracting, from the bitstream, the one or more processed volumetric primitives, the one or more precision presets, and the information associating the one or more precision presets with the one or more processed volumetric primitives. At 1030, the method includes decoding volumetric primitives from the one or more processed volumetric primitives using the one or more precision presets, and the information associating the one or more precision presets with the one or more processed volumetric primitives. At 1040, the method includes generating a media representation consisting of the volumetric primitives. Method 1000 may be implemented with decoder 500, receiving apparatus 682 with decoder 640, or apparatus 700.

The following examples are provided and described herein.

Example 1. An apparatus including: at least one processor; and at least one memory storing instructions that, when executed by the at least one processor, cause the apparatus at least to: receive one or more media frames each represented by one or more volumetric primitives; determine precision presets for processing the one or more volumetric primitives; process attributes of the one or more volumetric primitives according to the determined precision presets; associate the processed one or more volumetric primitives with the determined precision presets; store the processed one or more volumetric primitives in a bitstream; and store, in or along the bitstream, the determined precision presets and the association of the determined precision presets with the processed one or more volumetric primitives.

Example 2. The apparatus of example 1, wherein a precision preset of the determined precision presets comprises a collection of quantization values for different attributes of a volumetric primitive in a scene.

Example 3. The apparatus of example 1, wherein an attribute of the attributes of the one or more volumetric primitives comprises: a position, or a rotation, or a scale, or a covariance, or a color, or an alpha, or an opacity, or a transparency, or view dependent color, or spherical harmonics, or a frequency component.

Example 4. The apparatus of example 1, wherein an attribute of the attributes of the one or more volumetric primitives is described by one or more of the following: a bit depth, or a data type, or a number of components, or a component index, or a quantization type, or a quantization direction, or a minimum attribute value, or a maximum attribute value.

Example 5. The apparatus of example 1, wherein an attribute of the attributes of the one or more volumetric primitives comprises multiple components, and each component of the attribute is described differently.

Example 6. The apparatus of example 1, wherein the precision presets for processing the one or more volumetric primitives are determined: by analyzing a distribution of the one or more volumetric primitives in a media frame or in a sequence of media frames, or by analyzing a three-dimensional neighborhood of clusters of the one or more volumetric primitives, or by analyzing visual attributes of the one or more volumetric primitives, or based on a bounding box size of the one or more media frames, or manually by a content author.

Example 7. The apparatus of example 1, wherein the precision presets for processing the one or more volumetric primitives are determined through a learned approach comprising minimizing a visual loss compared to full-precision source content.

Example 8. The apparatus of example 1, wherein the precision presets for processing the one or more volumetric primitives are determined through a learned approach comprising minimizing a visual loss compared to a non-modified source view.

Example 9. The apparatus of example 1, wherein the precision presets for processing the one or more volumetric primitives are determined: per content, or per sequence of frames, or per frame, or per level of detail, or per frame tile.

Example 10. The apparatus of example 1, wherein the association of the processed one or more volumetric primitives with the determined precision presets is: per primitive, or per group of primitives, or per hierarchy of primitives, or per level of detail.

Example 11. The apparatus of example 1, wherein the at least one memory stores instructions that, when executed by the at least one processor, cause the apparatus at least to: signal, in or along the bitstream, the precision presets using a session description protocol.

Example 12. The apparatus of example 1, wherein the at least one memory stores instructions that, when executed by the at least one processor, cause the apparatus at least to: signal, in or along the bitstream, the precision presets using a media presentation description.

Example 13. The apparatus of example 1, wherein the at least one memory stores instructions that, when executed by the at least one processor, cause the apparatus at least to compress the determined precision presets for processing the one or more volumetric primitives by entropy coding indexes of the determined precision presets, wherein the entropy coding of the indexes of the determined precision presets comprises: defining a distance function between precision presets; predicting a candidate preset; and defining a probability distribution over all possible presets by computing a respective distance between each of the possible presets and the predicted preset; wherein defining the probability distribution comprises assigning lower probabilities to respective possible presets that are far from the predicted candidate preset.

Example 14. An apparatus including: at least one processor; and at least one memory storing instructions that, when executed by the at least one processor, cause the apparatus at least to: receive a bitstream comprising of at least one or more processed volumetric primitives, one or more precision presets, and information associating the one or more precision presets with the one or more processed volumetric primitives; extract, from the bitstream, the one or more processed volumetric primitives, the one or more precision presets, and the information associating the one or more precision presets with the one or more processed volumetric primitives; decode volumetric primitives from the one or more processed volumetric primitives using the one or more precision presets, and the information associating the one or more precision presets with the one or more processed volumetric primitives; and generate a media representation consisting of the volumetric primitives.

Example 15. The apparatus of example 14, wherein a precision preset of the determined precision presets comprises a collection of quantization values for different attributes of a volumetric primitive in a scene.

Example 16. The apparatus of example 14, wherein an attribute of a volumetric primitive of the volumetric primitives comprises: a position, or a rotation, or a scale, or a covariance, or a color, or an alpha, or an opacity, or a transparency, or view dependent color, or spherical harmonics, or a frequency component.

Example 17. The apparatus of example 14, wherein an attribute of a volumetric primitive of the volumetric primitives is described by one or more of the following: a bit depth, or a data type, or a number of components, or a component index, or a quantization type, or a quantization direction, or a minimum attribute value, or a maximum attribute value.

Example 18. The apparatus of example 14, wherein an attribute of a volumetric primitive of the volumetric primitives comprises multiple components, and each component of the attribute is described differently.

Example 19. The apparatus of example 14, wherein the one or more precision presets are associated with the one or more processed volumetric primitives: per primitive, or per group of primitives, or per hierarchy of primitives, or per level of detail.

Example 20. The apparatus of example 14, wherein the at least one memory stores instructions that, when executed by the at least one processor, cause the apparatus at least to: receive, in or along the bitstream, signaling of the one or more precision presets with a session description protocol.

Example 21. The apparatus of example 14, wherein the at least one memory stores instructions that, when executed by the at least one processor, cause the apparatus at least to: receive, in or along the bitstream, signaling of the one or more precision presets with a media presentation description.

Example 22. The apparatus of example 14, wherein the one or more precision presets have been compressed by entropy coding indexes of the one or more precision presets, wherein the entropy coding of the indexes of the one or more precision presets comprises: defining a distance function between precision presets; predicting a candidate preset; and defining a probability distribution over all possible presets by computing a respective distance between each of the possible presets and the predicted candidate preset; wherein defining the probability distribution comprises assigning lower probabilities to respective possible presets that are far from the predicted candidate preset.

Example 23. A method including: receiving one or more media frames each represented by one or more volumetric primitives; determining precision presets for processing the one or more volumetric primitives; processing attributes of the one or more volumetric primitives according to the determined precision presets; associating the processed one or more volumetric primitives with the determined precision presets; storing the processed one or more volumetric primitives in a bitstream; and storing, in or along the bitstream, the determined precision presets and the association of the determined precision presets with the processed one or more volumetric primitives.

Example 24. A method including: receiving a bitstream comprising of at least one or more processed volumetric primitives, one or more precision presets, and information associating the one or more precision presets with the one or more processed volumetric primitives; extracting, from the bitstream, the one or more processed volumetric primitives, the one or more precision presets, and the information associating the one or more precision presets with the one or more processed volumetric primitives; decoding volumetric primitives from the one or more processed volumetric primitives using the one or more precision presets, and the information associating the one or more precision presets with the one or more processed volumetric primitives; and generating a media representation consisting of the volumetric primitives.

Example 25. An apparatus including: means for receiving one or more media frames each represented by one or more volumetric primitives; means for determining precision presets for processing the one or more volumetric primitives; means for processing attributes of the one or more volumetric primitives according to the determined precision presets; means for associating the processed one or more volumetric primitives with the determined precision presets; means for storing the processed one or more volumetric primitives in a bitstream; and means for storing, in or along the bitstream, the determined precision presets and the association of the determined precision presets with the processed one or more volumetric primitives.

Example 26. An apparatus including: means for receiving a bitstream comprising of at least one or more processed volumetric primitives, one or more precision presets, and information associating the one or more precision presets with the one or more processed volumetric primitives; means for extracting, from the bitstream, the one or more processed volumetric primitives, the one or more precision presets, and the information associating the one or more precision presets with the one or more processed volumetric primitives; means for decoding volumetric primitives from the one or more processed volumetric primitives using the one or more precision presets, and the information associating the one or more precision presets with the one or more processed volumetric primitives; and means for generating a media representation consisting of the volumetric primitives.

Example 27. A computer readable medium including instructions stored thereon for performing at least the following: receiving one or more media frames each represented by one or more volumetric primitives; determining precision presets for processing the one or more volumetric primitives; processing attributes of the one or more volumetric primitives according to the determined precision presets; associating the processed one or more volumetric primitives with the determined precision presets; storing the processed one or more volumetric primitives in a bitstream; and storing, in or along the bitstream, the determined precision presets and the association of the determined precision presets with the processed one or more volumetric primitives.

Example 28. A computer readable medium including instructions stored thereon for performing at least the following: receiving a bitstream comprising of at least one or more processed volumetric primitives, one or more precision presets, and information associating the one or more precision presets with the one or more processed volumetric primitives; extracting, from the bitstream, the one or more processed volumetric primitives, the one or more precision presets, and the information associating the one or more precision presets with the one or more processed volumetric primitives; decoding volumetric primitives from the one or more processed volumetric primitives using the one or more precision presets, and the information associating the one or more precision presets with the one or more processed volumetric primitives; and generating a media representation consisting of the volumetric primitives.

In the above, some embodiments have been described in relation to the term quantization parameter. It is to be understood that embodiments may be similarly realized with reference to any similar term, such as quantizer, or control variable that defines or determines fidelity of the (de) coded video or image signal. In the above, some embodiments assume that the lower the quantization parameter value is, the better fidelity is achieved. It is to be understood that embodiments may be similarly realized with a control variable that has an opposite way of mapping values, i.e., the higher the control variable value is, the better fidelity is achieved. For example, embodiments may be realized with JPEG compression where the higher the quality factor is, the better fidelity is achieved.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
2DGS 2D Gaussian splat
3D three-dimensional
3DG 3D graphics
3DGS three-dimensional Gaussian splat
4DGS four-dimensional Gaussian splat
AC alternating current
ASIC application specific integrated circuit
CPU central processing unit
DC direct current
DCT Discrete Cosine Transform
DNN deep neural network
FFT fast Fourier transform
FPGA field programmable gate array
G-PCC geometry based point cloud compression
GPU graphics processing unit
GS Gaussian splat
HMD head-mounted display
IEC International Electrotechnical Commission
I/F interface
INRIA National Institute for Research in Digital Science and Technology
int integer
IoU intersection over union
I/O input/output
ISO International Organization for Standardization
JPEG Joint Photographic Experts Group
Lidar light detection and ranging
LoD, lod level of detail
MIV MPEG immersive video
MLP multi-layer perceptron
MPD media presentation description
MPEG moving picture experts group
NeRF neural radiance field
N/W network
PC point cloud
RAHT region adaptive hierarchical transform
RAM random access memory
RFM reference frame memory
RGB red green blue
RGBA red green blue alpha
ROM read only memory
SC subcommittee
SDP session description protocol
SH, sh spherical harmonics
SON self-organizing/optimizing network
u(n) unsigned integer using n bits (e.g. u(2))
ue(v) unsigned integer 0-th order Exp-Golomb-coded syntax element with the left bit first.
UI user interface
uint unsigned integer
USB universal serial bus
V3C visual volumetric video based coding
V-PCC video based point cloud compression
VVC versatile video coding
WG working group
YUV color model including a luma component Y, a chroma component U, and a chroma component V

1. An apparatus comprising: at least one processor; and at least one memory storing instructions that, when executed by the at least one processor, cause the apparatus at least to: receive one or more media frames each represented by one or more volumetric primitives; determine precision presets for processing the one or more volumetric primitives; process attributes of the one or more volumetric primitives according to the determined precision presets; associate the processed one or more volumetric primitives with the determined precision presets; store the processed one or more volumetric primitives in a bitstream; and store, in or along the bitstream, the determined precision presets and the association of the determined precision presets with the processed one or more volumetric primitives.

2. The apparatus of claim 1, wherein a precision preset of the determined precision presets comprises a collection of quantization values for different attributes of a volumetric primitive in a scene.

3. The apparatus of claim 1, wherein an attribute of the attributes of the one or more volumetric primitives comprises: a position, or a rotation, or a scale, or a covariance, or a color, or an alpha, or an opacity, or a transparency, or view dependent color, or spherical harmonics, or a frequency component.

4. The apparatus of claim 1, wherein an attribute of the attributes of the one or more volumetric primitives comprises multiple components, and each component of the attribute is described differently.

5. The apparatus of claim 1, wherein the precision presets for processing the one or more volumetric primitives are determined: by analyzing a distribution of the one or more volumetric primitives in a media frame or in a sequence of media frames, or by analyzing a three-dimensional neighborhood of clusters of the one or more volumetric primitives, or by analyzing visual attributes of the one or more volumetric primitives, or based on a bounding box size of the one or more media frames, or manually by a content author.

6. The apparatus of claim 1, wherein the precision presets for processing the one or more volumetric primitives are determined through a learned approach comprising minimizing a visual loss compared to full-precision source content.

7. The apparatus of claim 1, wherein the precision presets for processing the one or more volumetric primitives are determined through a learned approach comprising minimizing a visual loss compared to a non-modified source view.

8. The apparatus of claim 1, wherein the at least one memory stores instructions that, when executed by the at least one processor, cause the apparatus at least to: signal, in or along the bitstream, the precision presets using a session description protocol.

9. The apparatus of claim 1, wherein the at least one memory stores instructions that, when executed by the at least one processor, cause the apparatus at least to: signal, in or along the bitstream, the precision presets using a media presentation description.

10. The apparatus of claim 1, wherein the at least one memory stores instructions that, when executed by the at least one processor, cause the apparatus at least to: compress the determined precision presets for processing the one or more volumetric primitives by entropy coding indexes of the determined precision presets, wherein the entropy coding of the indexes of the determined precision presets comprises: defining a distance function between precision presets; predicting a candidate preset; and defining a probability distribution over all possible presets by computing a respective distance between each of the possible presets and the predicted preset; wherein defining the probability distribution comprises assigning lower probabilities to respective possible presets that are far from the predicted candidate preset.

11. An apparatus comprising: at least one processor; and at least one memory storing instructions that, when executed by the at least one processor, cause the apparatus at least to: receive a bitstream comprising of at least one or more processed volumetric primitives, one or more precision presets, and information associating the one or more precision presets with the one or more processed volumetric primitives; extract, from the bitstream, the one or more processed volumetric primitives, the one or more precision presets, and the information associating the one or more precision presets with the one or more processed volumetric primitives; decode volumetric primitives from the one or more processed volumetric primitives using the one or more precision presets, and the information associating the one or more precision presets with the one or more processed volumetric primitives; and generate a media representation consisting of the volumetric primitives.

12. The apparatus of claim 11, wherein a precision preset of the determined precision presets comprises a collection of quantization values for different attributes of a volumetric primitive in a scene.

13. The apparatus of claim 11, wherein an attribute of a volumetric primitive of the volumetric primitives comprises: a position, or a rotation, or a scale, or a covariance, or a color, or an alpha, or an opacity, or a transparency, or view dependent color, or spherical harmonics, or a frequency component.

14. The apparatus of claim 11, wherein an attribute of a volumetric primitive of the volumetric primitives is described by one or more of the following: a bit depth, or a data type, or a number of components, or a component index, or a quantization type, or a quantization direction, or a minimum attribute value, or a maximum attribute value.

15. The apparatus of claim 11, wherein an attribute of a volumetric primitive of the volumetric primitives comprises multiple components, and each component of the attribute is described differently.

16. The apparatus of claim 11, wherein the one or more precision presets are associated with the one or more processed volumetric primitives: per primitive, or per group of primitives, or per hierarchy of primitives, or per level of detail.

17. The apparatus of claim 11, wherein the at least one memory stores instructions that, when executed by the at least one processor, cause the apparatus at least to: receive, in or along the bitstream, signaling of the one or more precision presets with a session description protocol.

18. The apparatus of claim 11, wherein the at least one memory stores instructions that, when executed by the at least one processor, cause the apparatus at least to: receive, in or along the bitstream, signaling of the one or more precision presets with a media presentation description.

19. The apparatus of claim 11, wherein the one or more precision presets have been compressed by entropy coding indexes of the one or more precision presets, wherein the entropy coding of the indexes of the one or more precision presets comprises: defining a distance function between precision presets; predicting a candidate preset; and defining a probability distribution over all possible presets by computing a respective distance between each of the possible presets and the predicted candidate preset; wherein defining the probability distribution comprises assigning lower probabilities to respective possible presets that are far from the predicted candidate preset.

20. A method comprising: receiving a bitstream comprising of at least one or more processed volumetric primitives, one or more precision presets, and information associating the one or more precision presets with the one or more processed volumetric primitives; extracting, from the bitstream, the one or more processed volumetric primitives, the one or more precision presets, and the information associating the one or more precision presets with the one or more processed volumetric primitives; decoding volumetric primitives from the one or more processed volumetric primitives using the one or more precision presets, and the information associating the one or more precision presets with the one or more processed volumetric primitives; and generating a media representation consisting of the volumetric primitives.
